(19) United States
(12) Patent Application Publication
(10) Pub. No.: US 2020/0160207 A1
(43) Pub. Date: May 21, 2020

(54) AUTOMATED MODEL UPDATE BASED ON MODEL DETERIORATION

(71) Applicant: General Electric Company, Schenectady, NY (US)

(72) Inventors: Guiju SONG, Niskayuna, NY (US); Colin PARRIS, Brookfield, CT (US); Xiao BIAN, Niskayuna, NY (US); Huan TAN, Clifton Park, NY (US); Kiersten RALSTON, Niskayuna, NY (US); Shaopeng LIU, Clifton Park, NY (US); Dayu HUANG, Niskayuna, NY (US)

(21) Appl. No.: 16/191,826

(22) Filed: Nov. 15, 2018

(51) Int. Cl. G06N 20/00; H04L 29/08; G06F 11/34

(52) U.S. Cl. CPC G06N 20/00; G06F 11/3466; H04L 67/125

(57) ABSTRACT

The example embodiments are directed to a system and methods for determining to update a machine learning model based on model degradation. In one example, the method may include one or more of receiving data acquired at an edge of an Internet of things (IoT) network from an industrial asset, executing a machine learning model with the received data as input to generate a predictive output associated with the industrial asset, determining that a performance of the machine learning model on the edge has degraded based on the generated predictive output of the machine learning model, and transmitting information about the degraded performance of the machine learning model to a central server within the IoT network.

### BACKGROUND

Machine and equipment assets are engineered to perform particular tasks as part of a process. For example, assets can include, among other things, industrial manufacturing equipment on a production line, drilling equipment for use in mining operations, wind turbines that generate electricity on a wind farm, transportation vehicles (trains, subways, airplanes, etc.), gas and oil refining equipment, and the like. As another example, assets may include devices that aid in diagnosing patients such as imaging devices (e.g., X-ray or MRI systems), monitoring equipment, and the like. The design and implementation of these assets often takes into account both the physics of the task at hand, as well as the environment in which such assets are configured to operate.

Low-level software and hardware-based controllers have long been used to drive machine and equipment assets. However, the overwhelming adoption of cloud computing, increasing sensor capabilities, and decreasing sensor costs, as well as the proliferation of mobile technologies, have created opportunities for creating novel industrial and healthcare based assets with improved sensing technology and which are capable of transmitting data that can then be distributed throughout a network. As a consequence, there are new opportunities to enhance the business value of some assets through the use of novel industrial-focused hardware and software.

An industrial internet of things (IIoT) network incorporates machine learning and big data technologies to harness the sensor data, machine-to-machine (M2M) communication and automation technologies that have existed in industrial settings for years. The driving philosophy behind IIoT is that smart machines are better than humans at accurately and consistently capturing and communicating real-time data. This data enables companies to pick up on inefficiencies and problems sooner, saving time and money and supporting business intelligence (BI) efforts. IIoT holds great potential for quality control, sustainable and green practices, supply chain traceability and overall supply chain efficiency.

In an IIoT, edge devices sense or otherwise capture data and submit the data to a cloud platform or other central host. Edge devices may be used widely in a large variety of industrial applications. In a cloud-edge system, artificial intelligence (AI) models having machine learning capabilities are maintained in the cloud and operated based on key information that is collected from different edge devices. In particular, one edge device may run a few different AI models supported by the cloud for various problems, and on the other hand, one cloud model may support several different edge devices. This many-to-many relationship creates a challenge to a model and data management scheme. With the increasing number of AI models (that run in the cloud) and edge devices, various problems become critical. For example, a change of data pattern collected by edge devices may render the performance of the AI model diminished and unsatisfactory. Also, it can be difficult to know when to initiate a model update to characterize the newly emerged data stream/pattern or continue using the old model.

### SUMMARY

According to an aspect of an example embodiment, a computing system may include a processor configured to receive data acquired at an edge of an Internet of things (IoT) network from an industrial asset, execute a machine learning model based on the received data as input to generate a predictive output associated with the industrial asset, and determine that a performance of the machine learning model has degraded based on the generated predictive output, and a network interface configured to transmit information about the degraded performance of the machine learning model to a central server within the IoT network.

According to an aspect of another example embodiment, a method may include one or more of receiving data acquired at an edge of an Internet of things (IoT) network from an industrial asset, executing a machine learning model with the received data as input to generate a predictive output associated with the industrial asset, determining that a performance of the machine learning model has degraded based on the generated predictive output, and transmitting information about the degraded performance of the machine learning model to a central server within the IoT network.

According to an aspect of another example embodiment, a server may include a network interface, a storage device configured to store an updated machine learning model configured to receive data acquired at an edge of an Internet of things (IoT) network from an industrial asset and input and generate a predictive output associated with the industrial asset, and a processor configured to identify one or more edge devices associated with the industrial asset which are operating based on a previous machine learning model, and control the network interface to push the updated machine learning model to the identified one or more edge devices associated with the industrial asset via the IoT network.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a cloud computing system for industrial software and hardware in accordance with an example embodiment.

FIG. 2 is a diagram illustrating an industrial asset environment within an IIoT in accordance with an example embodiment.

FIG. 3 is a diagram illustrating a graph of an accuracy of a machine learning model over time in accordance with an example embodiment.

FIGS. 4A-4C are diagrams illustrating examples of model updates being performed between an edge and cloud platform in accordance with example embodiments.

FIG. 5A is a diagram illustrating a method of an edge device determining to update a machine learning model in accordance with an example embodiment.

FIG. 5B is a diagram illustrating a method of a cloud platform pushing a machine learning model to an edge device in accordance with an example embodiment.

FIG. 6 is a diagram illustrating a computing system configured for use within any of the example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation.

However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments are directed to a cloud-edge system in which updates to machine learning (ML) models (also referred to as artificial intelligence models) are automatically triggered based on an edge device, a cloud platform, or any combination thereof. According to various embodiments, an edge device may monitor an accuracy of an ML model over time and initiate a model update with the cloud platform when the accuracy of the model falls below a predetermined threshold. As another example, a cloud platform may receive updates to a ML model from other edge devices within a community of edge devices, and automatically push the updated ML model to another edge device within the same community.

ML models may be used to evaluate data captured by the edge with respect to a trained/reference set of data that is usually a base line of a performance of the asset. For example, ML models may be used to identify discriminate features which can be used to make predictions about an industrial asset such as when wear or damage has occurred to an asset, if instrument controls need to be changed based on external factors, if a part needs replacement, if materials should be ordered, and the like. For example, ML models may operate based on time-series data, images, audio, and the like, which may be captured by sensors (pressure, acoustic, temperature, motion, imaging, acoustic, etc.), and the like.

In the example of image data, the image data may be attempting to detect a specific feature from an industrial asset (e.g., damage to a surface of the asset, etc.) A machine learning model may be trained to identify how likely such a feature exists in an image. A result of the ML model output may be a data point for the image where the data point is arranged in a multi-dimensional feature space with a likelihood of the feature existing within the image being arranged on one axis (e.g., y axis) and time on another axis (e.g., x axis). As another example, time-series data may be used to monitor how a machine or equipment is operating over time. Time-series data may include temperature, pressure, speed, etc. Here, the ML model may be trained to identify how likely it is that the operation of the asset is normal or abnormal based on the incoming-time series data.

An ML model may be trained based on actual data from an industrial asset. Often, an initial training period occurs when an asset is established. However, over time, data being created or otherwise captured from an asset may change for various reasons. For example, machine and equipment assets may begin to deteriorate or wear-down creating a reduction in performance. As another example, unexpected changes in environment can cause unexpected changes to the data. As another example, maintenance operations and/or upgrades of parts and systems may occur creating improvements in the performance of the asset. The performance of the machine learning algorithms may deteriorate when data patterns within the edge data begin to stray from the data patterns of the initial training data.

The example embodiments improve upon the prior art by detecting when a performance of a ML model has deteriorated and needs to be replaced or otherwise updated. In some embodiments, an edge device may detect that the model is no longer operating as expected and may request a cloud platform for an update. Here, the cloud platform may update the model and provide the updated model the edge device. As another example the edge device may automatically update the model locally and transmit the updated model to the cloud platform. As another example, the cloud platform may push a model update received from another edge device to the device. Here, the receiving edge device may decided whether or not to accept the new model.

To perform the ML model update, the edge-cloud system may generate a new data set of data points from received edge data which differ from the data pattern of the initial training data. A clustering program can run continuously on the new data set to identify clusters of continuous data points which differ by the predetermined distance from the data pattern in the initial training data set. When the clustering program identifies a cluster of data points within the new data set having a predetermined threshold size (e.g., 100 data points, etc.) the edge can request (or the cloud can automatically trigger) an update to the ML model. In response, the cloud may train a new ML model or updated an existing ML model based on the data within the new data set.

The process of training an ML model involves providing an ML algorithm (i.e., the learning algorithm) with training data to learn from. The term ML model refers to the model artifact that is created by the training process. The training data must contain the correct answer, which is known as a target or target attribute. The learning algorithm finds patterns in the training data that map the input data attributes to the target (i.e., the answer to predict), and it outputs an ML model that captures these patterns.

The system and method described herein may be implemented via a program or other software that may be used in conjunction with applications for managing machine and equipment assets hosted within an industrial internet of things (IIoT). An IIoT may connect assets, such as turbines, jet engines, locomotives, elevators, healthcare devices, mining equipment, oil and gas refineries, and the like, to the Internet or cloud, or to each other in some meaningful way such as through one or more networks. The cloud can be used to receive, relay, transmit, store, analyze, or otherwise process information for or about assets and manufacturing sites. In an example, a cloud computing system includes at least one processor circuit, at least one database, and a plurality of users and/or assets that are in data communication with the cloud computing system. The cloud computing system can further include or can be coupled with one or more other processor circuits or modules configured to perform a specific task, such as to perform tasks related to asset maintenance, analytics, data storage, security, or some other function.

Assets may be outfitted with one or more sensors (e.g., physical sensors, virtual sensors, etc.) configured to monitor respective operations or conditions of the asset and the environment in which the asset operates. Data from the sensors can be recorded or transmitted to a cloud-based or other remote computing environment. By bringing such data into a cloud-based computing environment, new software applications informed by industrial process, tools and know-how can be constructed, and new physics-based analytics specific to an industrial environment can be created. Insights gained through analysis of such data can lead to enhanced asset designs, enhanced software algorithms for operating the same or similar assets, better operating efficiency, and the like.

The edge-cloud system may be used in conjunction with applications and systems for managing machine and equipment assets and can be hosted within an IIoT. For example, an IIoT may connect physical assets, such as turbines, jet engines, locomotives, healthcare devices, and the like, software assets, processes, actors, and the like, to the Internet or cloud, or to each other in some meaningful way such as through one or more networks. The system described herein can be implemented within a “cloud” or remote or distributed computing resource. The cloud can be used to receive, relay, transmit, store, analyze, or otherwise process information for or about assets. In an example, a cloud computing system includes at least one processor circuit, at least one database, and a plurality of users and assets that are in data communication with the cloud computing system. The cloud computing system can further include or can be coupled with one or more other processor circuits or modules configured to perform a specific task, such as to perform tasks related to asset maintenance, analytics, data storage, security, or some other function.

While progress with industrial and machine automation has been made over the last several decades, and assets have become ‘smarter,’ the intelligence of any individual asset pales in comparison to intelligence that can be gained when multiple smart devices are connected together, for example, in the cloud. Aggregating data collected from or about multiple assets can enable users to improve business processes, for example by improving effectiveness of asset maintenance or improving operational performance if appropriate industrial-specific data collection and modeling technology is developed and applied.

The integration of machine and equipment assets with the remote computing resources to enable the IIoT often presents technical challenges separate and distinct from the specific industry and from computer networks, generally. To address these problems and other problems resulting from the intersection of certain industrial fields and the IIoT, the example embodiments provide a mechanism for triggering an update to a ML model upon detection that the incoming data is no longer represented by the data pattern within the training data which was used to initially train the ML model.

As described in various examples herein, data may include a raw collection of related values of an asset or a process/operation including the asset, for example, in the form of a stream (in motion) or in a data storage system (at rest). Individual data values may include descriptive metadata as to a source of the data and an order in which the data was received, but may not be explicitly correlated. Information may refer to a related collection of data which is imputed to represent meaningful facts about an identified subject. As a non-limiting example, information may be a dataset such as a dataset which has been determined to represent temperature fluctuations of a machine part over time.

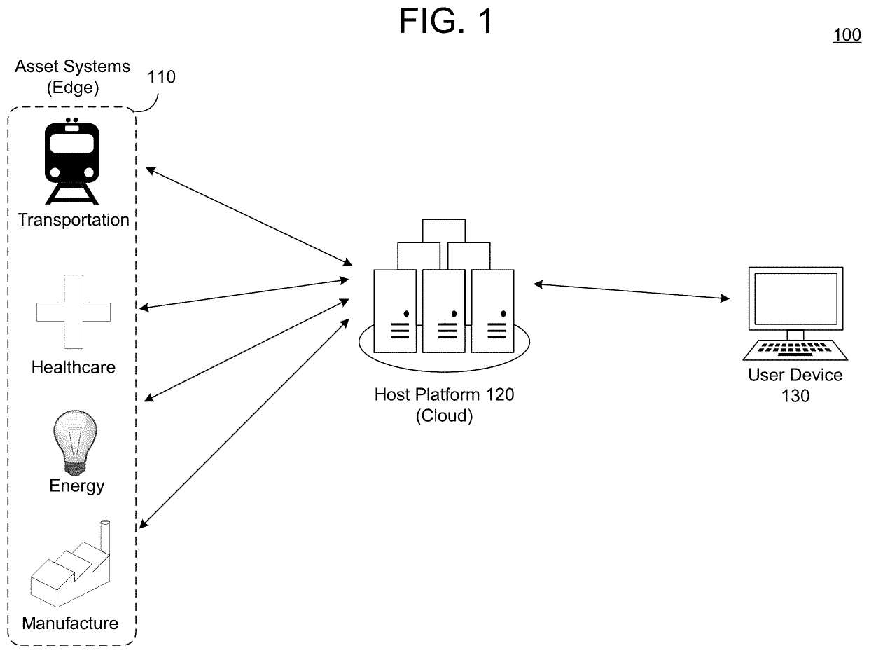

FIG. 1 illustrates a cloud computing system 100 for industrial software and hardware in accordance with an example embodiment. Referring to FIG. 1, the system 100 includes a plurality of assets 110 which may be included within an edge of an IIoT and which may transmit raw data to a source such as cloud computing platform 120 where it may be stored and processed. It should also be appreciated that the cloud platform 120 in FIG. 1 may be replaced with or supplemented by a non-cloud based platform such as a server, an on-premises computing system, and the like. Assets 110 may include hardware/structural assets such as machine and equipment used in industry, healthcare, manufacturing, energy, transportation, and that like. It should also be appreciated that assets 110 may include software, processes, actors, resources, and the like. A digital replica (i.e., a digital twin) of an asset 110 may be generated and stored on the cloud platform 120. The digital twin may be used to virtually represent an operating characteristic of the asset 110.

The data transmitted by the assets 110 and received by the cloud platform 120 may include raw time-series data output as a result of the operation of the assets 110, and the like. Data that is stored and processed by the cloud platform 120 may be output in some meaningful way to user devices 130. In the example of FIG. 1, the assets 110, cloud platform 120, and user devices 130 may be connected to each other via a network such as the Internet, a private network, a wired network, a wireless network, etc. Also, the user devices 130 may interact with software hosted by and deployed on the cloud platform 120 in order to receive data from and control operation of the assets 110.

Software and hardware systems can be used to enhance or otherwise used in conjunction with the operation of an asset and a digital twin of the asset (and/or other assets), may be hosted by the cloud platform 120, and may interact with the assets 110. For example, ML models (or AI models) may be used to optimize a performance of an asset or data coming in from the asset. As another example, the ML models may be used to predict, analyze, control, manage, or otherwise interact with the asset and components (software and hardware) thereof. The ML models may also be stored in the cloud platform 120 and/or at the edge (e.g. asset computing systems, edge PC's, asset controllers, etc.)

A user device 130 may receive views of data or other information about the asset as the data is processed via one or more applications hosted by the cloud platform 120. For example, the user device 130 may receive graph-based results, diagrams, charts, warnings, measurements, power levels, and the like. As another example, the user device 130 may display a graphical user interface that allows a user thereof to input commands to an asset via one or more applications hosted by the cloud platform 120.

In some embodiments, an asset management platform (AMP) can reside within or be connected to the cloud platform 120, in a local or sandboxed environment, or can be distributed across multiple locations or devices and can be used to interact with the assets 110. The AMP can be configured to perform functions such as data acquisition, data analysis, data exchange, and the like, with local or remote assets, or with other task-specific processing devices. For example, the assets 110 may be an asset community (e.g., turbines, healthcare, power, industrial, manufacturing, mining, oil and gas, elevator, etc.) which may be communicatively coupled to the cloud platform 120 via one or more intermediate devices such as a stream data transfer platform, database, or the like.

Information from the assets 110 may be communicated to the cloud platform 120. For example, external sensors can be used to sense information about a function, process, operation, etc., of an asset, or to sense information about an environment condition at or around an asset, a worker, a downtime, a machine or equipment maintenance, and the like. The external sensor can be configured for data communication with the cloud platform 120 which can be configured to store the raw sensor information and transfer the raw sensor information to the user devices 130 where it can be accessed by users, applications, systems, and the like, for further processing. Furthermore, an operation of the assets 110 may be enhanced or otherwise controlled by a user inputting commands though an application hosted by the cloud platform 120 or other remote host platform such as a web server. The data provided from the assets 110 may include time-series data or other types of data associated with the operations being performed by the assets 110

In some embodiments, the cloud platform 120 may include a local, system, enterprise, or global computing infrastructure that can be optimized for industrial data workloads, secure data communication, and compliance with regulatory requirements. The cloud platform 120 may include a database management system (DBMS) for creating, monitoring, and controlling access to data in a database coupled to or included within the cloud platform 120. The cloud platform 120 can also include services that developers can use to build or test industrial or manufacturing-based applications and services to implement IIoT applications that interact with assets 110.

For example, the cloud platform 120 may host an industrial application marketplace where developers can publish their distinctly developed applications and/or retrieve applications from third parties. In addition, the cloud platform 120 can host a development framework for communicating with various available services or modules. The development framework can offer developers a consistent contextual user experience in web or mobile applications. Developers can add and make accessible their applications (services, data, analytics, etc.) via the cloud platform 120. Also, analytic software may analyze data from or about a manufacturing process and provide insight, predictions, and early warning fault detection.

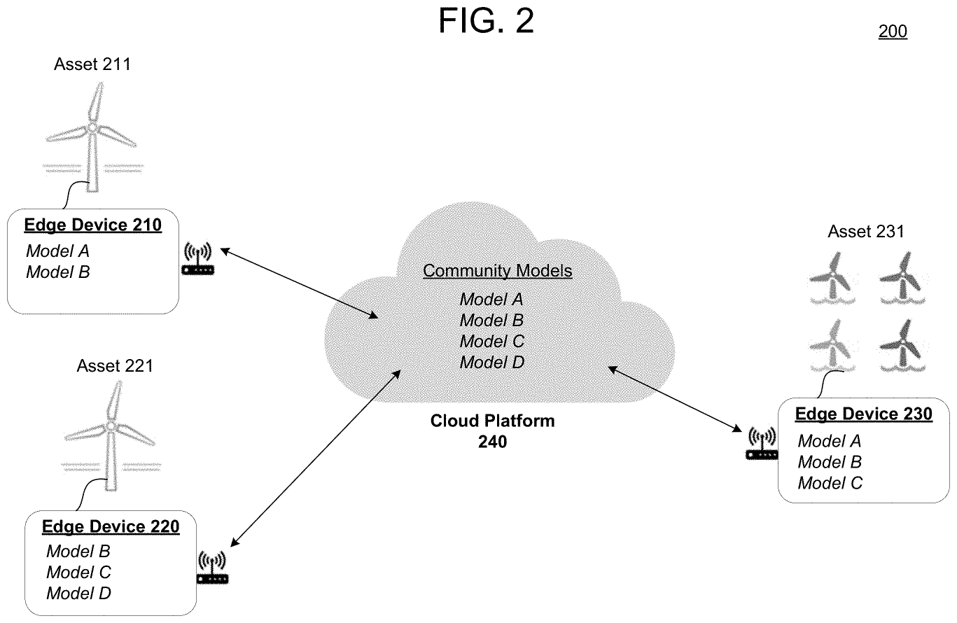

FIG. 2 illustrates an industrial asset environment 200 within an IIoT in accordance with an example embodiment. Referring to FIG. 2, a plurality of assets 211, 221, and 231 are connected to a cloud platform 240 via a plurality of respective edge devices 210, 220, and 230. For example, the assets 211, 221, and 231 may be the same type of asset such as a wind turbine or any other type of industrial asset. However, the assets are not limited to a wind turbine and it should be appreciated that this is just one example. As another example, the assets may be a same type of industrial machine or equipment such as locomotives, engines, gas turbines, elevators, or other types of machine or equipment. Meanwhile, the edge devices 210, 220, and 230 may be computing systems such as edge servers, asset controllers, on-premises servers, user devices, or the like.

According to various embodiments, the cloud platform 240 maintains a plurality of community models which include machine learning models which can be used by the edge devices 210, 220, and 230 to identify or otherwise predict operating features of respective assets 211, 221, and 231 during operation. The cloud platform 240 may initially train and subsequently update/modify community models based on collaborative data provided from multiple edge devices/assets.

As an example, an edge device (e.g., 210, 220, 230, etc.) and the cloud platform 240 may detect that a community model is no longer operating as expected and update the model based on new data being provided from one or more of the edge devices. In some cases, the models may be updated based on data from multiple edge devices. When a community machine learning model is updated locally at one edge device (e.g., edge device 210, etc.), the cloud platform 240 may then disseminate the updated community model to other edge devices (e.g., edge devices 220 and 230, etc.) within the environment 200.

The example embodiments improve operations between local machine learning models on the edge devices (210, 220, 230, etc.) of the environment 200 and community machine learning models maintained by the cloud platform 240. It provides methods on evaluating situations in which an edge device and the cloud platform 240 should communicate and exchange models or meta model parameters, and schedules communications from both edge and cloud sides. An edge device may evaluate an accuracy performance of a machine learning model to determine whether a model needs to be updated. For example, evaluation metrics may include input (sensory) data variation, output data variation from prediction models, model output confidence levels, and the like. Pre-set thresholds or human defined thresholds for the metrics may be rules to determine the trigger of edge/cloud communication. In situations where connectivity between edge and cloud is strictly infrequent, communication may be trigged whenever connection is available. Rule based decision will be an override.

The example embodiments enable automated communication between the edge devices 210-230 and the cloud platform 240 and identify when the edge devices 210-230 and/or the cloud platform 240 should communicate and exchange models or meta parameters of models. According to various aspects, communication between edge and cloud can enhance the model accuracy on the edge by leveraging knowledge gained from all other edges in the community, and vice versa, enhance the community models on cloud by aggregating new data from edges or locally improved models with learning on edges, and the like. Continual exchange or communication between edge and cloud may increase network cyber risk, cost of transmitting data, and burden to the network bandwidth. The example embodiments enable edge-cloud communication when it is necessary.

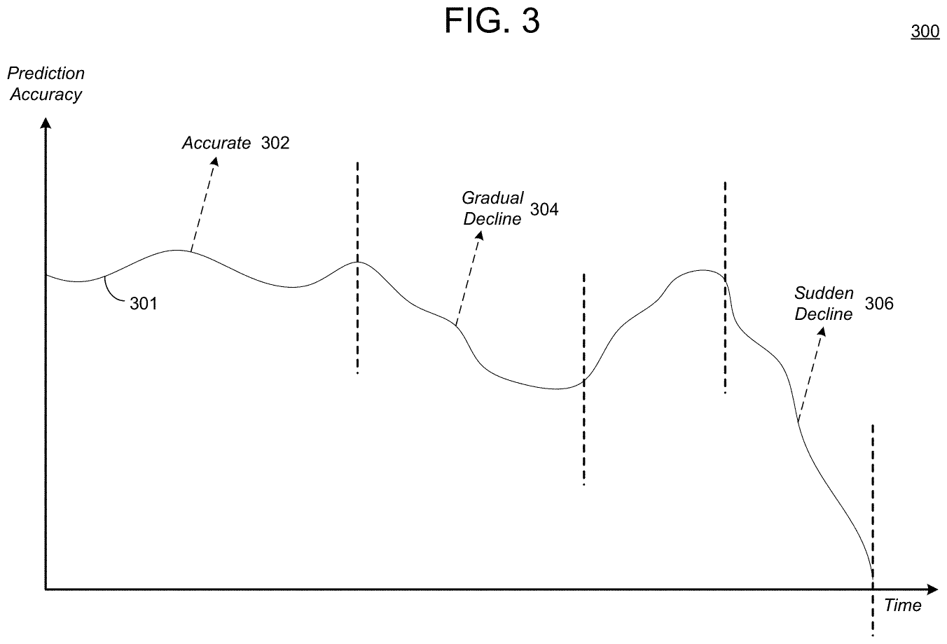

FIG. 3 illustrates a graph 300 of an accuracy of a machine learning model over time in accordance with an example embodiment. Accuracy may be determined by comparing predictive values to actual values, after the fact. Here, the predicted values may be predictions as to whether maintenance is needed, parts are needed, supplies are needed, damage has occurred, etc. with respect to an industrial asset. In some cases, accurate data may be accumulated by the cloud and disseminated to edge devices to enable accuracy analysis of a machine learning model. As another example, actual values may be stored by the edge devices over time and used to confirm accuracy of predicted values.

As shown in the example of FIG. 3, an accuracy of a machine learning model is measured by a line 301 over time. The example of FIG. 3 illustrates a common occurrence within machine learning model accuracy. As shown in region 302 of the graph 300, the prediction accuracy of the model is high (above a predetermined threshold, etc.). However, over time, the accuracy may begin to gradually decline as shown in region 304 of the graph 300. Ultimately, the predication accuracy of the machine learning model may decline to the point where it is no longer reliable in predicting a discriminate value associated with the industrial asset such as shown in region 306 of the graph 300.

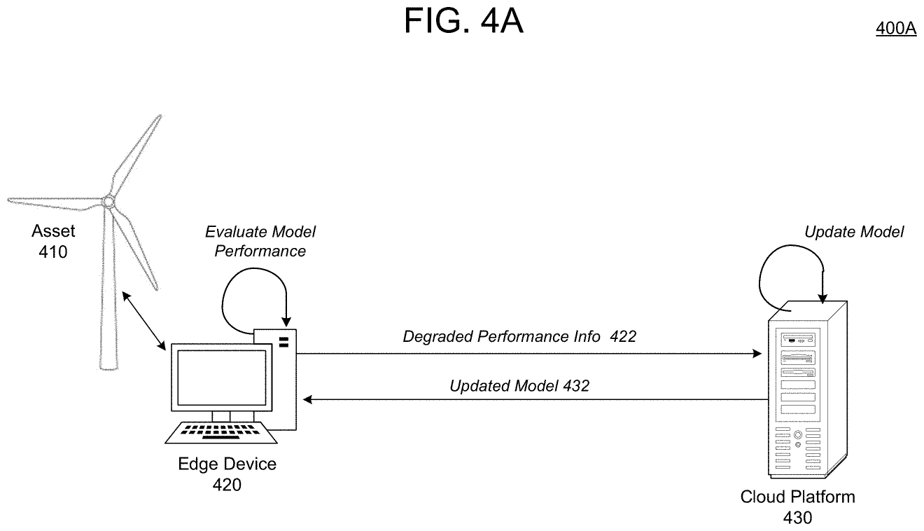

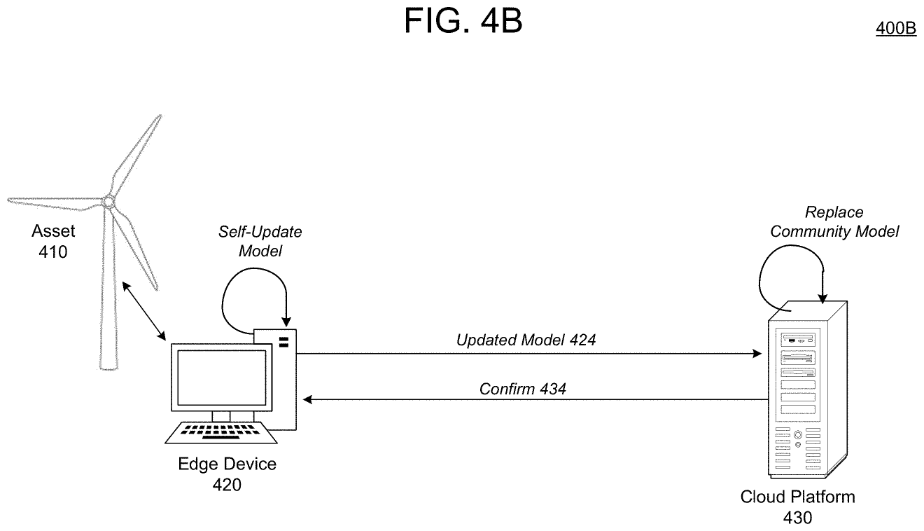

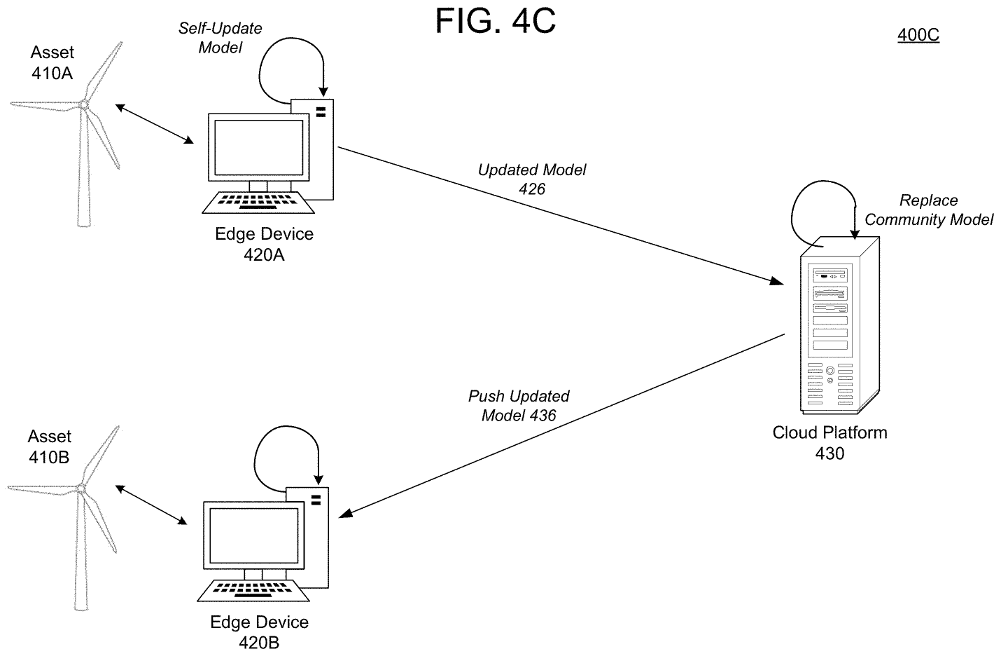

FIGS. 4A-4C illustrate examples of model updates being performed between an edge and cloud platform in accordance with example embodiments. Referring to FIG. 4A, a process 400A is shown in which an edge device 420 detects that a performance of an ML model has degraded and transmits a request 422 indicating the degraded performance to a cloud platform 430. In this example, the edge device 420 executes one or more ML models based on data acquired from an asset 410. In response, the cloud platform 430 may update the model and transmit a response 432 to the edge device 420 including the updated model.

Referring to FIG. 4B, a process 400B is shown in which the edge device 420 detects that the performance of the ML model has degraded and automatically self-updates the ML model locally at the edge device 420 based on data acquired from the edge device. Here, the edge device 420 may retrain the model or train a new model based on new data in comparison to data which was used to initially train the ML model. In this example, the edge device 420 transmits a message 424 to the cloud platform 430 which includes the updated model. In response, the cloud platform 430 may update a community model that is used by other edge devices and transmit a confirmation message 434 to the edge device 420.

Referring to FIG. 4C, a process 400C is shown in which a first edge device 420A and a second edge device 420B are both sensing data associated with a same type of asset (wind turbine). Here, the first edge device 420A senses data from an asset 410A and the second edge device 420B senses data from an asset 410B. In this example, the first edge device 420A may determine that a local ML model is not performing accurately and locally update the ML model, similar to the process described in FIG. 4B. The first edge device 420A may transmit a message 426 including the updated model to the cloud platform 430. In this case, the cloud platform 430 may update a community model stored at the cloud based on the updates to the local model of the first edge device 420A, and further push the updated model to the second edge device 420B within a push message request 436. In response, the second edge device 420B may decide to accept or deny the request to update. Furthermore, if the second edge device 420B accepts the update, then a local model may be updated at the second edge device 420B based on the community model updated by the cloud platform 430

The example embodiments may be performed in various scenarios. In one example, an edge device may initiate communication to 1) request for model update from the cloud or 2) to transmit local AI models on edge retrained with real time streaming data or meta model parameters to the cloud for improving the community models. In another example, a cloud system initiates communication to push enhanced community AI models to an edge device as new foundational models. The enhanced community AI models should have better prediction performance than the previous generations of community AI models because of aggregated intelligence from all local models on a distributed edge community. Edge systems can decide to accept or reject the model update requested from cloud.

Asset state changes with time. Sensory data collected from distributed assets can change over time too. This often results in poor and degraded prediction performance in predictive models that assume static relationships between input and output variables. Model performance degradation applies for both regression models (continuous output) or classification models (nominal or binary output or categorized severity level).

In the edge communication example, the communication can be implemented in two ways. One way is to calculate the data shifts on edge by calculating mean value, median, standard deviation and other similar metrics for time series data and compare the shifts with preset or human defined thresholds. For image or video based inspection data, the data shift metrics can be the histogram of pixel densities in an image or video frame. When the sensory or inspection data shifts exceed threshold, request for model update from edge may be triggered. An alternative way is to assess the model prediction accuracy by tracking the model output confidence or calculating the predicted output distribution. When the output distribution or model prediction confidence varies more than preset threshold, model update request from edge to cloud may be triggered.

When the input data shift or model output variation is gradual and less than the preset threshold, the real time streaming data and online learning are used to improve the Predictive model on edge. If a network connection or access to cloud is available promptly, requests for local AI model updating may be sent to cloud. The most recent community AI models on cloud will be sent to edge for re-training. In case there is no new generation of community AI models on cloud other than the ones that edge systems received last time, both edge and cloud should trigger a request for human intervention. In case the network connection or access to cloud is not available when the trigger is initiated by edge, communication between edge and cloud may occur whenever the network access is established and a trigger on edge for human intervention in local operation environment should be activated.

In an example in which a cloud platform initiates communication, the community AI models residing on cloud may be updated when new training data or new edge AI models (including meta parameters for models) are received. These updated models will may be the new generation of community AI models. The cloud side may initiate communication with all edge systems to demand model update. Edge systems should assess their individual model accuracy and determine whether they accept updates demanded from cloud or not. If the network connection between edge and cloud is infrequent or irregular, demand from cloud should be sent when connections are established.

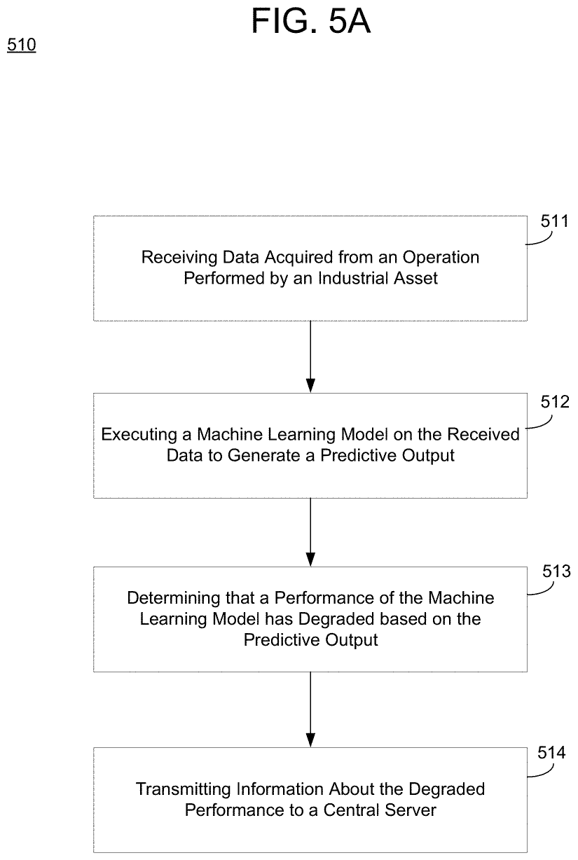

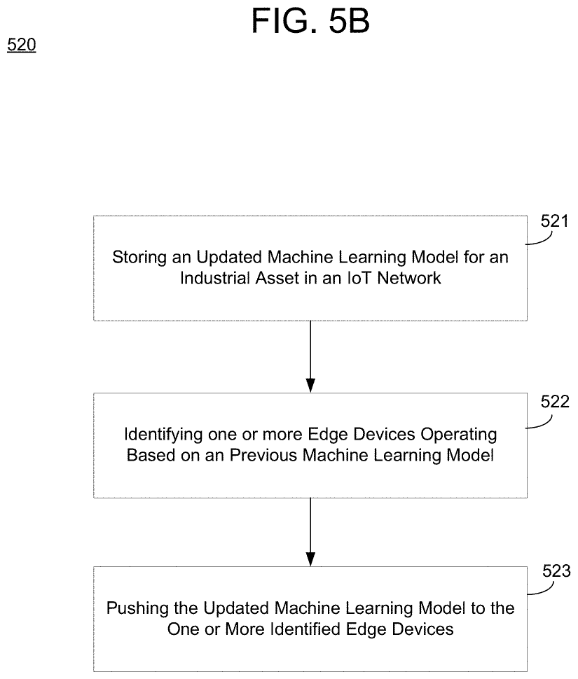

FIG. 5A illustrates a method 510 of an edge device determining to update a machine learning model in accordance with an example embodiment. For example, the method 510 may be performed by an edge device such as a computing system connected to or embedded within an industrial asset, a cloud computing platform, web server, a database, and the like, or a combination of devices such as a combination of a cloud platform and an edge computing system. Referring to FIG. 5A, in 511, the method may include receiving data acquired at an edge of an Internet of things (IoT) network from an operation performed by an industrial asset. For example, the data acquired at the edge may include one or more of time-series data sensed by a sensor, image data captured by a camera, and audio data captured by a microphone.

In 512, the method may include executing a machine learning model with the received data as input to generate a predictive output associated with the industrial asset. For example, the machine learning model comprises a predictive model configured to identify discriminate features within the received data. The machine learning model may be used to predict features about the industrial asset such as damage has occurred to the asset, parts need to be ordered, various controls need to be changed to adjust for external factors, and the like.

In 513, the method may include determining that a performance of the machine learning model has degraded based on the generated predictive output. In some embodiments, the determining may include determining that the generated predictive output deviates by a predetermined threshold from a historical predictive output pattern of the machine learning model. In some embodiments, the determining may include generating metadata including a confidence level of the machine learning model based on the generated predictive output. In some embodiments, the determining may include determining that the generated predictive output of the machine learning model has degraded in response to the generated confidence level being less than a predetermined confidence threshold.

In 514, the method may include transmitting information about the degraded performance of the machine learning model to a central server within the IoT network. For example, the transmitting may include transmitting, to the central server, a request for an update to the machine learning model in response to determining the generated predictive output has degraded. As another example, the transmitting may include transmitting a confidence level, a generated output of the model execution, and the like. In some embodiments, the method may further include updating the machine learning model at the edge based on the received data, and the transmitting may include transmitting, to the central server, the updated machine learning model.

FIG. 5B illustrates a method 520 of a server pushing a machine learning model to an edge device in accordance with an example embodiment. For example, the server may be a cloud platform, an intervening edge server, an asset controller, an on-premises device, and the like. Referring to FIG. 5B, in 521, the method may include storing an updated machine learning model configured to receive data acquired at an edge of the IoT network from an operation performed by an industrial asset and input and generate a predictive output associated with the industrial asset. The updated machine learning model may be updated internally by a central server based on edge data. As another example, the updated machine learning model may be updated by an edge device and then provided to the central server.

In 522, the method may include identifying one or more edge devices associated with the industrial asset which are operating based on a previous machine learning model, and in 523 the method may include transmitting the updated machine learning model to the identified one or more edge devices associated with the industrial asset via the IoT network. In some embodiments, the transmitting may include automatically pushing the updated machine learning model from the server to the identified one or more edge devices in response to the previous machine learning model being updated by the updated machine learning model.

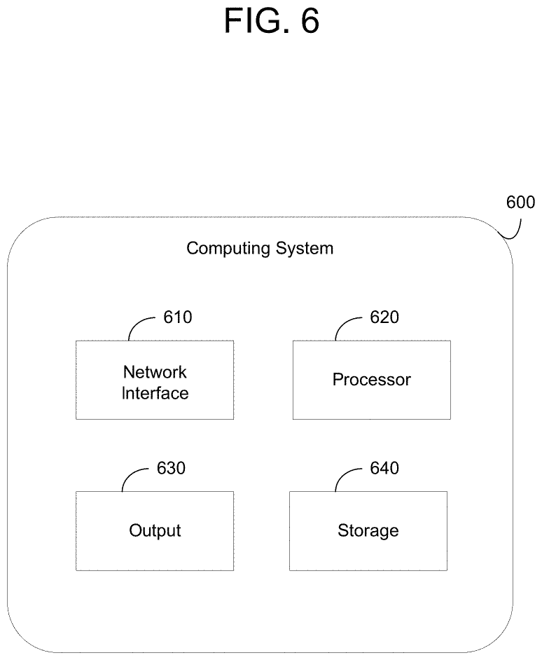

FIG. 6 illustrates a computing system 600 for use in accordance with an example embodiment. For example, the computing system 600 may be an edge computing device, a cloud platform, a server, a database, and the like. In some embodiments, the computing system 600 may be distributed across multiple devices such as both an edge computing device and a cloud platform. Also, the computing system 600 may perform the methods 510 of FIG. 5A and 520 of FIG. 5B. Referring to FIG. 6, the computing system 600 includes a network interface 610, a processor 620, an output 630, and a storage device 640 such as a memory. Although not shown in FIG. 6, the computing system 600 may include other components such as a display, an input unit, a receiver, a transmitter, and the like.

The network interface 610 may transmit and receive data over a network such as the Internet, a private network, a public network, and the like. The network interface 610 may be a wireless interface, a wired interface, or a combination thereof. The processor 620 may include one or more processing devices each including one or more processing cores. In some examples, the processor 620 is a multicore processor or a plurality of multicore processors. Also, the processor 620 may be fixed or it may be reconfigurable. The output 630 may output data to an embedded display of the computing system 600, an externally connected display, a display connected to the cloud, another device, and the like.

The storage device 640 is not limited to a particular storage device and may include any known memory device such as RAM, ROM, hard disk, and the like, and may or may not be included within the cloud environment. The storage 640 may store software modules or other instructions which can be executed by the processor 620 to perform the method 400 shown in FIG. 4. Also, the storage 640 may store software programs and applications which can be downloaded and installed by a user. Furthermore, the storage 640 may store and the processor 620 may execute an application marketplace that makes the software programs and applications available to users that connect to the computing system 600.

According to various embodiments, the processor 620 may receive data acquired at an edge of an IoT network from an operation performed by an industrial asset, execute a machine learning model based on the received data as input to generate a predictive output associated with the industrial asset, and determine that a performance of the machine learning model has degraded based on the generated predictive output. In this example, the network interface 610 may transmit information about the degraded performance of the machine learning model to a central server such as a cloud platform, web server, database, on-premises server, intervening edge server, or the like, within the IoT network.

In some embodiments, the data acquired at the edge may include time-series data sensed by one or more of a sensor, a camera, and a microphone. As another example, the data may include images, audio, or the like. The machine learning model may include a predictive model configured to identify discriminate features within the received data. In some embodiments, the processor 620 may determine that the generated predictive output deviates by a predetermined threshold from a historical predictive output pattern of the machine learning model. In some embodiments, the processor 620 may generate metadata that includes a confidence level of the machine learning model based on the generated predictive output.

In some embodiments, the processor 620 may determine that the generated predictive output of the machine learning model has degraded in response to the generated confidence level being less than a predetermined confidence threshold. In some embodiments, the processor 620 may control the network interface 610 to transmit, to the central server, a request for an update to the machine learning model in response to the processor determining the generated predictive output has degraded. In some embodiments, the processor 620 may update the machine learning model at the edge based on the received data, and control the network interface 610 to transmit, to the central server, the updated machine learning model.

As another example, the computing device 600 may be a web server. In this example, the storage device 640 may store an updated machine learning model configured to receive data acquired at an edge of the IoT network from an operation performed by an industrial asset and input and generate a predictive output associated with the industrial asset. In this example, the processor 620 may identify one or more edge devices associated with the industrial asset which are operating based on a previous machine learning model, and control the network interface 610 to push the updated machine learning model to the identified one or more edge devices associated with the industrial asset via the IoT network.

In this example, the network interface 610 may receive the updated machine learning model from a first edge device and transmit the updated machine learning model to a second edge device that is different than the first edge device. In some embodiments, the processor 620 may update the machine learning to generate the updated machine learning model based on model data collaboratively provided from a plurality of edge devices associated with the industrial asset. In some embodiments, the processor 620 may control the network interface 610 to automatically push the updated machine learning model from the server to the identified one or more edge devices in response to the previous machine learning model being updated by the updated machine learning model.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a processor configured to receive data acquired at an edge of an Internet of things (IoT) network from an industrial asset, execute a machine learning model based on the received data as input to generate a predictive output associated with the industrial asset, and determine that a performance of the machine learning model has degraded based on the generated predictive output; and
a network interface configured to transmit information about the degraded performance of the machine learning model to a central server within the IoT network.

2. The computing system of claim 1, wherein the data acquired at the edge comprises one or more of time-series data sensed by a sensor, image data captured by a camera, and audio data captured by a microphone.

3. The computing system of claim 1, wherein the machine learning model comprises a predictive model configured to identify discriminate features within the received data.

4. The computing system of claim 1, wherein the processor is configured to determine that the generated predictive output deviates by a predetermined threshold from a historical predictive output pattern of the machine learning model.

5. The computing system of claim 1, wherein the processor is configured to generate metadata that includes a confidence level of the machine learning model based on the generated predictive output.

6. The computing system of claim 5, wherein the processor is further configured to determine that the generated predictive output of the machine learning model has degraded in response to the generated confidence level being less than a predetermined confidence threshold.

7. The computing system of claim 1, wherein the network interface is configured to transmit, to the central server, a request for an update to the machine learning model in response to the processor determining the generated predictive output has degraded.

8. The computing system of claim 1, wherein the processor is further configured to update the machine learning model at the edge based on the received data, and the network interface is configured to transmit, to the central server, the updated machine learning model.

9. A method comprising:
receiving data acquired at an edge of an Internet of things (IoT) network from an industrial asset;
executing a machine learning model with the received data as input to generate a predictive output associated with the industrial asset;
determining that a performance of the machine learning model has degraded based on the generated predictive output; and
transmitting information about the degraded performance of the machine learning model to a central server within the IoT network.

10. The method of claim 9, wherein the data acquired at the edge comprises one or more of time-series data sensed by a sensor, image data captured by a camera, and audio data captured by a microphone.

11. The method of claim 9, wherein the machine learning model comprises a predictive model configured to identify discriminate features within the received data.

12. The method of claim 9, wherein the determining comprises determining that the generated predictive output deviates by a predetermined threshold from a historical predictive output pattern of the machine learning model.

13. The method of claim 9, wherein the determining comprises generating metadata including a confidence level of the machine learning model based on the generated predictive output.

14. The method of claim 13, wherein the determining further comprises determining that the generated predictive output of the machine learning model has degraded in response to the generated confidence level being less than a predetermined confidence threshold.

15. The method of claim 9, wherein the transmitting comprises transmitting, to the central server, a request for an update to the machine learning model in response to determining the generated predictive output has degraded.

16. The method of claim 9, further comprising updating the machine learning model at the edge based on the received data, and the transmitting comprises transmitting, to the central server, the updated machine learning model.

17. A server comprising:
a network interface;
a storage device configured to store an updated machine learning model configured to receive data acquired at an edge of an Internet of things (IoT) network from an industrial asset and input and generate a predictive output associated with the industrial asset; and
a processor configured to identify one or more edge devices associated with the industrial asset which are operating based on a previous machine learning model, and control the network interface to push the updated machine learning model to the identified one or more edge devices associated with the industrial asset via the IoT network.

18. The server of claim 17, wherein the network interface is further configured to receive the updated machine learning model from a first edge device and transmit the updated machine learning model to a second edge device that is different than the first edge device.

19. The server of claim 17, wherein the processor is further configured to update the machine learning to generate the updated machine learning model based on model data collaboratively provided from a plurality of edge devices associated with the industrial asset.

20. The server of claim 17, wherein the network interface is configured to automatically push the updated machine learning model from the server to the identified one or more edge devices in response to the previous machine learning model being updated by the updated machine learning model.
